(19) United States
(12) Patent Application Publication
(10) Pub. No.: US 2006/0260063 A1
(43) Pub. Date: Nov. 23, 2006

(54) Cleaning method

(76) Inventors: J. P. Liew, Perak (MY); Antony Morton, Yorkshire (GB); Dwight Payne, St. Simons Island, GA (US); Craig Valentine, Summerville, SC (US)

Correspondence Address: VOITH FABRICS, 3040 BLACK CREEK ROAD, P.O. BOX 1411, WILSON, NC, 27893, US

(21) Appl. No.: 11/394,059

(22) Filed: Mar. 29, 2006

(30) Foreign Application Priority Data
Apr. 1, 2005 (DE) 10 2005 014 937.5

(51) Int. Cl. C11D 3/00

(52) U.S. Cl. 8/115.51

(57) ABSTRACT

The present invention relates to a method for cleaning and/or conditioning a fabric in a machine for producing and/or processing a material web, in particular a fibrous web such as a paper, board or tissue web, in which suitable meassures are carried out in order to set an intended state for specific properties of the fabric, the suitable measures being determined while taking account of the specific structure of the fabric to be cleaned.

### CROSS-REFERENCE TO RELATED APPLICATIONS

The present application claims priority under 35 U.S.C. §119 of German Patent Application No. 10 2005 014 937.5 filed on Apr. 1, 2005, the disclosure of which is expressly incorporated by reference herein in its entirety.

### BACKGROUND OF INVENTION

1. Field of the Invention

The present invention relates to a method for cleaning and/or conditioning a fabric in a machine for producing and/or processing a material web, for example a fibrous web such as a paper, board or tissue web.

2. Discussion of Background Information

Fabrics in web-processing machines are continually subject to the influence of contaminants, which have a detrimental effect on their action.

For instance, in a paper machine a large number of fabrics are used to transport and dewater a fibrous web to be produced. The fabrics are constructed, for example, as forming fabrics in the forming section, as press felts in the press section and as dryer fabrics in the drying section or as transfer belts. The fabrics and felts are often constructed, at least to some extent, as woven fabric belts with an open pore structure.

During the operation of the paper machine, the fabrics are soiled to an increasing extent, for example by contaminants such as adhesives or other additives contained in the fibrous suspension. For example, in a fabric belt, the pores and meshes become clogged with the aforementioned substances over time.

A number of devices for cleaning a fabric in a web-processing machine are known from the prior art.

For example, EP 0 731 212 A1 discloses a cleaning device having rotatable cleaning nozzles. According to this document, the cleaning nozzles are inclined towards the transport path, the direction of inclination of the nozzles changing continuously between an inclination in the running direction of the transport path and an inclination counter to the direction of the transport path, as a result of the rotation of the nozzles. Experience shows that the cleaning methods which can be carried out with such a cleaning device often lead to inadequate cleaning results.

### SUMMARY OF THE INVENTION

Accordingly, an object of the present invention is a method for cleaning and/or conditioning a fabric whereby improved cleaning performance, for example when removing dirt, can be achieved.

In the method for cleaning and/or conditioning a fabric in a machine for producing and/or processing a material web, suitable measures are carried out in order to set an intended state for specific properties of the fabric, the suitable measures being determined while taking account of the structure of the fabric.

For example, the term structure, on its own or in combination, can comprise the following, for example: In the case of a multilayer fabric the structure of the individual layers and their stacking sequence relative to one another in the fabric, the type of weave of a woven structure, the materials used for the various layers or the one layer, in the case of a woven structure, the form and the diameter of the threads, in the case of felts the stacking sequence of the fibre batts relative to one another and relative to the base fabric which, for example, is a woven fabric structure, the fibre thickness in the fibre batt, and so on.

The present invention is based on the finding that, for example, paper machine fabrics have a fundamentally different structure to one another, depending on the intended use, that is to say as a forming fabric or press felt or dryer fabric, and that these different structures cannot be cleaned and conditioned equally effectively with the same conditions.

The present invention is further based on the finding that fabrics with different structures exhibit different contamination trends with regard to the type of contamination, distribution of the contamination on the fabric, strength of the adhesion of the contamination to the fabric and the like, and it is thus necessary to treat these contaminants specific to a specific structure of the fabric, accordingly, specifically. The same applies to the conditioning, for example by means of drying the fabric. Here, too, there are specific conditions for the structure of the fabric.

On account of the large number of extremely different structures in paper machine fabrics, board machine fabrics or tissue machine fabrics, there is thus a need for optimal adaptation of the cleaning and/or conditioning conditions to the respective structure of the fabric. This is provided by the method according to the present invention.

For example, a forming fabric normally comprises a woven structure, while a press felt typically comprises a woven layer and one or more nonwoven layers.

But even in forming fabrics, there are again great structural differences, depending on the specific application. For instance, forming fabrics for the production of graphic papers have the smoothest possible paper-side surface, whereas, for instance, forming fabrics for the production of tissue paper have a rough or textured paper-side surface in order to provide the formation of a most voluminous and absorbent tissue paper.

Using the method according to the present invention, cleaning and conditioning are performed in which the measures suitable for this purpose are determined by taking account of the specific structure of the fabric to be cleaned in each case. Consequently, the cleaning and conditioning become more effective.

According to a preferred embodiment of the method according to the present invention, provision is made for the structure of the fabric to be stored as data in a database, to which a control and/or regulating unit which determines the suitable measures has access. Accordingly, one embodiment could consist in each fabric being supplied with a data set describing its specific structure and the data set being loaded into a control and/or regulating unit acting on the cleaning device, so that this cleaning device can then clean the fabric optimally, taking account of its specific structure appropriately, and, on account of the data set reproducing the structure of the fabric, a cleaning and/or conditioning sequence matched to the structure of the fabric being run.

The aforementioned data set can be stored, for example, on a transportable data medium, such as a CD or a floppy disk.

The method according to the present invention can, moreover, provide for the actual state of at least one specific property of the fabric to be determined continuously or cyclically and for the actual state determined to be taken into account when determining the suitable measures. Ideally, in this case the actual state determined is provided to the control and/or regulating unit in the form of data, so the control and/or regulating unit determines or can determine suitable measures while taking account of the structure of the fabric and of the actual state of the at least one specific property of the fabric.

As a specific property for characterizing the fabrics, for example, their permeability and/or their moisture content and/or their contamination may be named, this enumeration not being intended to be final.

More advantageously, in the method according to the present invention, the actual state of the fabric is determined with local resolution in the cross-machine direction, so that, as a countermove, suitable measures can be determined selectively in the cross-machine direction and can be carried out.

The suitable measures are carried out either continuously or cyclically or depending on need, for example depending on the specific requirements during the production process of the material web.

Different measures are conceivable by means of which a material web, in particular a fibrous web, can be cleaned or conditioned. According to an advantageous development of the method according to the present invention, provision is made for the suitable measures to comprise acting on the fabric with a fluid cleaning medium. This measure currently represents the most common method for cleaning and/or conditioning the fabric. However, it could entirely be possible in the future that other methods, not yet known to date, are more suitable for specific structures of fabrics and would be applied to the cleaning and/or conditioning of these fabrics.

The fluid cleaning medium can in this example be liquid and/or gaseous and is in particular water or steam or air or CO₂ or a mixture of at least two of these components.

Additionally or optionally, the suitable measure can further comprise a vacuum acting on the fabric.

On the basis of the currently widespread methods for applying fluid and the action of vacuum, the suitable measures advantageously comprise the setting of parameters for acting on the fabric with the fluid cleaning medium and/or relating to the action of the vacuum.

Possible parameters are, for example, in each case being conceivable on their own or in combination: the angle of incidence of the cleaning medium on the fabric in relation to the machine direction and to the cross-machine direction; the direction of impingement of the cleaning medium relative to the fabric, for example relative to the direction of movement of the fabric; the application pressure of the cleaning medium; the quantity of cleaning medium applied to one point of the fabric; the time of application of the cleaning medium to a specific point of the fabric; the flow of the cleaning medium during the application to the fabric; the distance between the nozzle from which the cleaning medium emerges and the fabric; and the size of the jet of the cleaning medium striking the fabric.

All of the conceivable parameters can act on the fabric on their own or in combination with one another in a manner varying in terms of location and time.

Mentioned by way of example are two fabrics having different woven structures, the woven structure for example of the paper-side surface of the first fabric being marked by long floating lengths of the filaments running in the CD direction and the paper-side surface of the second fabric being marked, for example, by long floating lengths of the filaments running in the MD direction. For both fabrics, no equally effective cleaning would take place from a jet of cleaning medium which is oriented in the MD direction relative to the fabric. Instead, an effective cleaning action can be achieved if the fluid jet strikes the fabric while oriented in the CD direction in the case of the first fabric and in the MD direction in the case of the second fabric.

There are many further examples of woven fabric structures in which the cleaning jet has to strike the fabric at a specific angle and in a specific direction relative to the fabric in order to achieve a good cleaning action.

Advantageously, data about the set parameters are provided continuously or cyclically to the control and/or regulating unit, so that the control and/or regulating unit determines the suitable measures while taking account of the structure of the fabric and of the actual state of the at least one specific property of the fabric and of the set parameters.

In this manner, a closed control loop is formed.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an example of a closed control loop according to the invention for cleaning and conditioning a fabric,

FIG. 2 shows an example relating to the possible direction of impingement of a cleaning jet on a fabric having a woven pattern, and

FIG. 3 shows an example relating to the possible cleaning parameters in the method according to the invention.

### DETAILED DESCRIPTION OF THE PRESENT INVENTION

The particulars shown herein are by way of example and for purposed of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

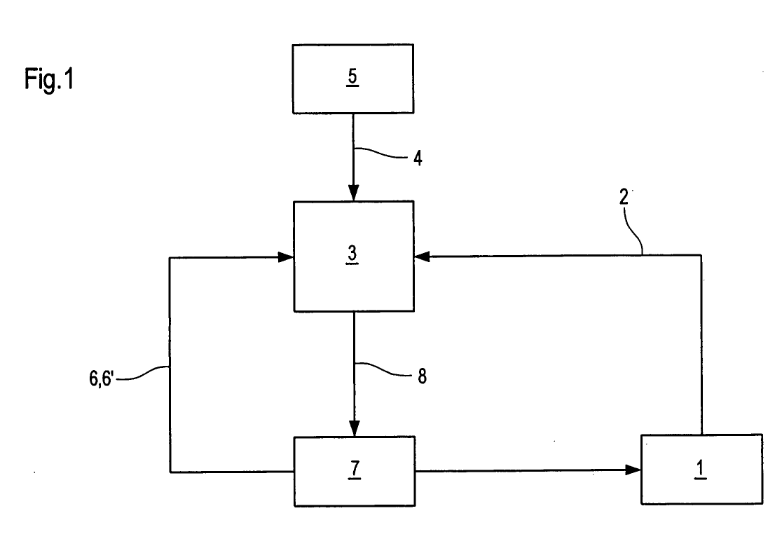

FIG. 1 shows a block diagram of a closed control loop for carrying out the method according to the invention for cleaning and/or conditioning a fabric, for example a fabric belonging to a paper machine.

In a block 1, the actual state of at least one specific property of the fabric is determined continuously or cyclically. These are properties such as the permeability and/or the moisture content and/or the contamination of the fabric.

The actual state of the specific properties is in this example determined with local resolution in the cross-machine direction.

The actual state determined of the at least one specific property is provided in the form of data 2 to a control and/or regulating unit 3.

The control and regulating unit 3 also receives data 4 from a database 5. The data 4 contain information about the specific structure of the fabric to be cleaned and to be conditioned.

Furthermore, the control and regulating unit 3 receives parameter data 6 which indicate the current state of actuating elements of a cleaning device 7 and thus the cleaning parameters which, for example, define the angle of incidence of the cleaning medium on the fabric, the direction of impingement of the cleaning medium on the fabric relative to the fabric, the pressure application of the cleaning medium, the quantity of cleaning medium applied to one point of the fabric, the time of application of the cleaning medium to a specific point of the fabric, the flow of the cleaning medium during the application to the fabric, the distance between the nozzle from which the cleaning medium emerges and the fabric, the size of the jet of cleaning medium striking the fabric and the like.

The control and regulating unit 3 determines suitable measures 8 by means of which influence is exerted on the cleaning device 7 and new parameter data 6′, that is to say parameters for cleaning and conditioning the fabric, are set, while taking into account the structure data 4 of the fabric and the actual state data 2 of the at least one specific property of the fabric and of the set parameter data 6.

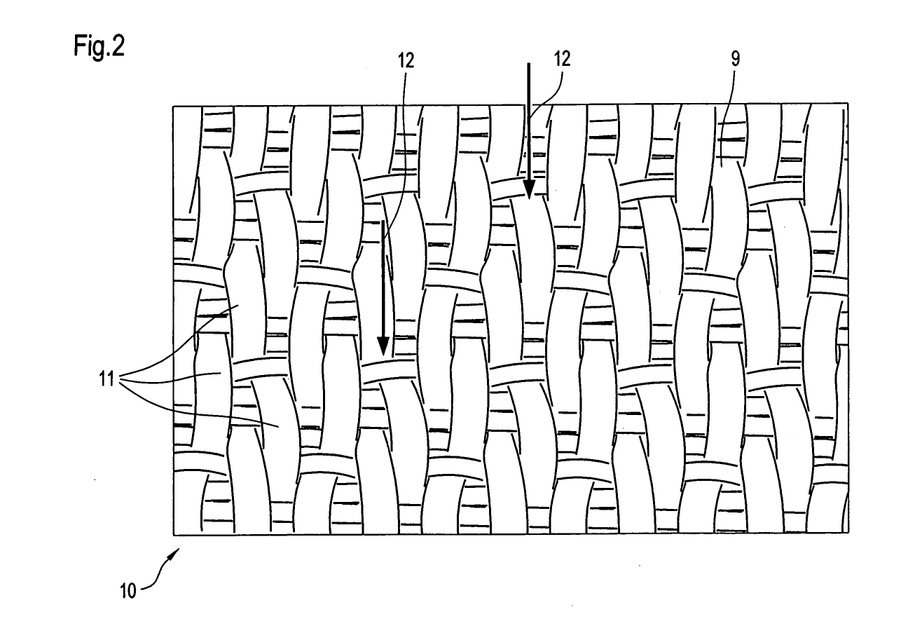

FIG. 2 shows in a perspective illustration of a detail of the surface 9 of a woven paper machine fabric 10 having a first woven pattern. Although the woven surface 9 has floating lengths 11, it is nevertheless relatively flat. It is possible to see arrows 12, which indicate the optimum direction of impingement of a fluid cleaning jet on the surface 9 relative to the latter.

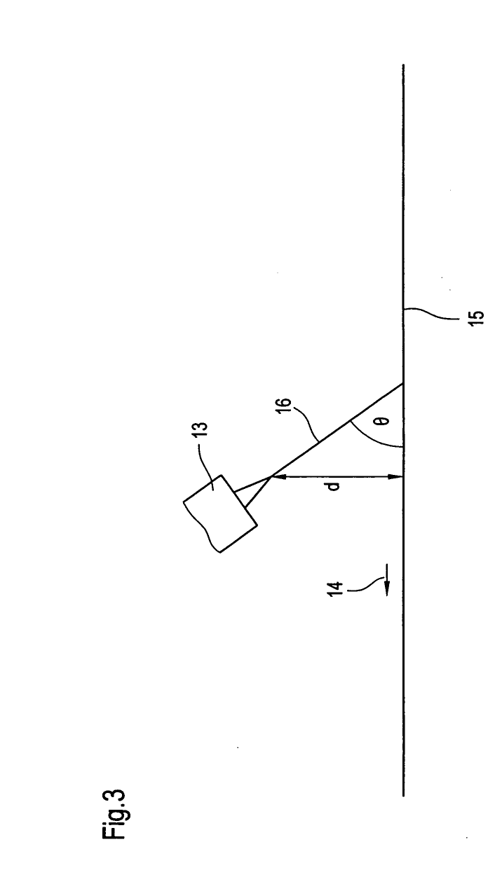

FIG. 3 shows a cleaning nozzle 13 whose distance d is set on the basis of the structure of a fabric 15 during the cleaning of the fabric 15. In addition, depending on the structure of the fabric 15, the cleaning jet 16 is aimed against the fabric at an angle θ relative to the fabric 15. Likewise on the basis of the structure of the fabric, the cleaning jet 16 is oriented in or counter to the running direction 14 of the fabric 15, in the present example the cleaning jet 16 being oriented counter to the running direction 14 of the fabric 15.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present extends to all functionally equivalent structures, methods and uses, such as are within the scope of the appended claims.

We claim:

1. A method for treating a fabric in a machine for at least one of producing and processing a material web, comprising the steps of:
setting a predetermined state for at least one predetermined property of the fabric; and
determining suitable treating measures;
wherein the fabric has a specific structure, and
wherein suitable treating measures take into account the specific structure of the fabric to be cleaned.

2. The method of claim 1, wherein the treating of the fabric is at least one of cleaning the fabric and conditioning the fabric.

3. The method of claim 1. wherein the material web is a fibrous web.

4. The method of claim 3, wherein the fibrous web is one of a paper web, a board web ans a tissue web.

5. The method of claim 1, wherein the structure of the fabric is stored as data in a database, and wherein at least one of a control unit and a regulating unit have access.

6. The method of claim 5, wherein the at least one control unit and regulating unit determine suitable treating measures.

7. The method of claim 1, further comprising the steps of:
determining an actual state of the at least one specific property of the fabric at least one of continuously and cyclically; and
using the actual state to determine the suitable treating measures.

8. The method of claim 7, further comprising the steps of:
providing the actual state to the at least one control unit and regulating unit in the form of data; and
determining suitable treatment measures while taking account the structure of the fabric and the actual state of the at least one specific property of the fabric.

9. The method of claim 7, wherein the at least one specific property of the fabric is at least one of permeability of the fabric, moisture content of the fabric and contamination of the fabric.

10. The method of claim 7, wherein the actual state is determined with local resolution in a cross-machine direction.

11. The method of claim 1, wherein the suitable treating measures are carried out at least one of continuously and cyclically.

12. The method of claim 1, wherein the suitable treating measures comprise acting on the fabric with a fluid cleaning medium.

13. The method of claim 12, wherein the fluid cleaning medium is at least one of a liquid and a gas.

14. The method of claim 13, wherein the at least one of a liquid and a gas is one of water, steam, air and CO₂.

15. The method of claim 13, wherein the at least one of a liquid and a gas is at least two of water, steam, air and CO₂.

16. The method of claim 1, wherein the suitable treating measure comprises applying a vacuum on the fabric.

17. The method of claim 1, wherein the suitable treating measures comprise setting of parameters for acting on the fabric with at least one of a fluid cleaning medium and applying a vacuum.

18. The method of claim 17, wherein that the parameters comprise at least one of: angle of incidence of the cleaning medium on the fabric, application pressure of the cleaning medium, quantity of cleaning medium applied to a point on the fabric, duration of application of the cleaning medium to a specific point on the fabric, flow of the cleaning medium during application to the fabric, distance between a nozzle from which the cleaning medium emerges and the fabric, and size of a jet of the cleaning medium striking the fabric.

19. The method of claim 17, further comprising the steps of providing data about the parameters one of continuously and cyclically to at least one of the control unit and the regulating unit, and
determining suitable treating measures while taking account of the structure of the fabric and of the actual state of the at least one specific property of the fabric and of the parameters.
